(19) United States
(12) Patent Application Publication
(10) Pub. No.: US 2015/0337087 A1
(43) Pub. Date: Nov. 26, 2015

(54) REMOVAL OF METALS FROM LIQUID PYROLYSIS OIL

(71) Applicants: Guangci Zhou, El Cerrito, CA (US); Stephen Harold Roby, Hercules, CA (US); Christopher W. Kuehler, Larkspur, CA (US)

(72) Inventors: Guangci Zhou, El Cerrito, CA (US); Stephen Harold Roby, Hercules, CA (US); Christopher W. Kuehler, Larkspur, CA (US)

(73) Assignee: Chevron U.S.A. Inc., San Ramon, CA (US)

(21) Appl. No.: 14/819,171

(22) Filed: Aug. 5, 2015

Related U.S. Application Data
(63) Continuation-in-part of application No. 14/158,089, filed on Jan. 17, 2014.

(51) Int. Cl. C08H 8/00

(52) U.S. Cl. CPC C08H 8/00

(57) ABSTRACT

The present disclosure generally relates to removing metals from liquid-phase pyrolysis oil, such as at or near room temperatures. Specifically, some embodiments of the disclosure relate to a method and a system for removing metals from pyrolysis oil using acidic ion-exchange resins. One embodiment relates to a method for removing metals from pyrolysis oil comprising combining pyrolysis oil and an organic solvent to form a pyrolysis oil mixture and removing metal from the pyrolysis oil mixture to produce a reduced metal content pyrolysis oil mixture. In some embodiments, the removing of the metal uses a strongly acid ion-exchange resin.

This application is a continuation-in-part of application Ser. No. 14/158,089, filed on Jan. 17, 2014.

### TECHNICAL FIELD

The present disclosure generally relates to removing metals from liquid pyrolysis oil. Specifically, some embodiments of the disclosure relate to a method and a system for removing metals from pyrolysis oil using acidic ion-exchange resins at lower temperatures.

### BACKGROUND

Pyrolysis oil is made from biomass, waste plastics, and other such carbon based material by the thermal decomposition of the material in the absence of oxygen. In the example of biomass, the pyrolysis splits the cellulose and lignin chains into smaller units. Pyrolysis oil mainly comprises water (20-28%), suspended solids and pyrolytic lignin (22-36%), hydroxyacetaldehyde (8-12%), and a host of other components such as levoglucosan, acetic acid, acetol, cellubiosan, glyoxal, formaldehyde, and formic acid. The oxygen content of the pyrolysis oil is approximately 40%. The pH of pyrolysis oil is between 1.5 and 3.8, which can require special processing equipment. Fast pyrolysis oil is the condensed product of pyrolysis gases and organic vapors from materials that are rapidly heated at temperatures around 500 degrees Celsius without oxygen.

Pyrolysis oil can either be directly burned as fuel or used as a potential feedstock in petroleum refineries. It is estimated that the pyrolysis oil might replace up to 60% of transportation fuels. It would significantly reduce the dependency on petroleum crude oil. Oil refiners would like to use pyrolysis oils as crude oil substitutes or extenders, blending the pyrolysis oil into conventional crude oil, and then processing the mixture in existing plants. However, the low pH, enormous oxygen content of non-water components, and large metal concentrations make co-processing the pyrolysis oil difficult. Refining equipment is subject to corrosion by low molecular weight organic acids. Additionally, pyrolysis oil can have high levels of contaminant metals, such as from greater than 100 ppmw to as high as 20,000 ppmw. In one embodiment, the contaminant metals can comprise calcium, potassium, magnesium, iron, sodium, and mixtures thereof. These contaminant metals can poison the catalysts used in refining processes and, therefore, must be removed in advance. The metals in pyrolysis oil could be removed by adsorbents or ion-exchange resins. However, the nature of pyrolysis oil makes the metal removal process difficult. For example, pyrolysis oil can be highly viscous. Its kinematic viscosity at 20 degrees Celsius can be greater than 200 mm²/s, such as in a range from 400 to 5000 mm²/s. Although heating can reduce pyrolysis oil's kinematic viscosity, the poor thermal stability of pyrolysis oil limits the temperature that can be used. Some pyrolysis oils can self-polymerize at elevated temperatures. Even at a safe temperature of around 60 degrees Celsius, in some embodiments, the kinematic viscosity of the pyrolysis oil can still be as high as 20 to 100 mm²/s at 20° C. Additionally, the inhomogeneity of pyrolysis oil can be another problem when removing metals from the pyrolysis oil.

Embodiments of this disclosure address ways to make pyrolysis oil homogenous and less viscous at room temperature, and provide ways to remove metals from pyrolysis oil at room temperature.

### SUMMARY

Embodiments of the disclosure relate to removing metals from pyrolysis oil. One embodiment is a method for removing metals from pyrolysis oil comprising combining pyrolysis oil and an organic solvent to form a pyrolysis oil mixture and removing metals from the pyrolysis oil mixture to produce a reduced metal content pyrolysis oil mixture. In one embodiment, the metals in pyrolysis oil can be in an un-complexed cationic form. The metals can be removed from the pyrolysis oil mixture using an acidic ion-exchange resin, such as a strongly acid ion-exchange resin. In embodiments, the pyrolysis oil and organic solvent may be mixed together prior to metal removal, and the mixing may be active or passive. The pyrolysis oil mixture can comprise 40-95% pyrolysis oil and 5-60% organic solvent. In embodiments of the disclosure, the organic solvent is ethanol, propanol, ethylene glycol, acetone, and mixtures thereof. In specific embodiments, the pyrolysis oil mixture comprises 5-40%, or 10-20% ethanol, propanol, or combinations thereof. In embodiments, the pyrolysis oil mixture comprises 40-50% pyrolysis oil, 40-50% ethylene glycol, and 5-15% acetone. In certain embodiments, the pyrolysis oil mixture has a kinematic viscosity at 20° C. less than 60 mm²/s, or less than 40 mm²/s. In one embodiment, the pyrolysis oil mixture has a kinematic viscosity at 20° C. between 1 and 60 mm²/s. The pyrolysis oil mixture may be filtered or not filtered prior to metal removal. In some embodiments, the pyrolysis oil mixture does not need to be heated prior to or during the step of removing the metals from the pyrolysis oil mixture.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

The present invention may suitably comprise, consist of, or consist essentially of, the elements in the claims, as described herein.

### BRIEF DESCRIPTION OF THE DRAWINGS

For a more complete understanding of the present invention, reference is now made to the following descriptions taken in conjunction with the accompanying drawings.

FIG. 1 is a graph showing the kinematic viscosity of a pyrolysis oil sample vs. weight percent propanol. The x-axis is the propanol ratio (w/w %) in the mixture, while the y-axis is the kinematic viscosity at 20° C. in mm²/s.

FIG. 2 is a graph showing the equilibrium isotherm results of a pyrolysis oil sample in an acetone-ethylene glycol mixed solvent with a strongly acidic ion-exchange resin (Amberlyst® 15). The x-axis is the weight resin over the weight pyrolysis oil in percent, while the y-axis is the percentage of metal removal for five metals. The metals in the graph are as follows: K (dash), Na (circle), Ca (diamond), Mg (triangle), and Fe (square).

FIG. 3 is a graph showing the removal of potassium using three different acidic ion-exchange resins. The x-axis shows the weight resin over the weight pyrolysis oil in percent. The y-axis is the percentage of metal removal. The different resins are represented by three different labels; triangle represents Acidic Resin A, diamond represents Acidic Resin B, and square represents Acidic Resin C.

FIG. 4 is a graph showing the removal of sodium using three different acidic ion-exchange resins. The x-axis shows the weight resin over the weight pyrolysis oil in percent. The y-axis is the percentage of metal removal. The different resins are represented by three different labels; triangle represents Acidic Resin A, diamond represents Acidic Resin B, and square represents Acidic Resin C.

FIG. 5 is a graph showing the removal of calcium using three different acidic ion exchange resins. The x-axis shows the weight resin over the weight pyrolysis oil in percent. The y-axis is the percentage of metal removal. The different resins are represented by three different labels; triangle represents Acidic Resin A, diamond represents Acidic Resin B, and square represents Acidic Resin C.

FIG. 6 is a graph showing the removal of magnesium using three different acidic ion exchange resins. The x-axis shows the weight resin over the weight pyrolysis oil in percent. The y-axis is the percentage of metal removal. The different resins are represented by three different labels; triangle represents Acidic Resin A, diamond represents Acidic Resin B, and square represents Acidic Resin C.

FIG. 7 is a graph showing the removal of iron using three different acidic ion exchange resins. The x-axis shows the weight resin over the weight pyrolysis oil in percent. The y-axis is the percentage of metal removal. The different resins are represented by three different labels; triangle represents Acidic Resin A, diamond represents Acidic Resin B, and square represents Acidic Resin C.

FIG. 8 is a graph of a kinetic study that shows that the removal of different cations from a pyrolysis oil mixture using a strongly acid ion-exchange resin is a pseudo first-order process.

### DETAILED DESCRIPTION

Embodiments of the disclosure relate to a method to remove metals from pyrolysis oil. Specifically, embodiments of the method relate to using a solvent to reduce the kinematic viscosity and increase the homogeneity of pyrolysis oil. Additional embodiments include removal of metals from the pyrolysis oil with acidic ion-exchange resins.

As used herein, the term “equal” refers to equal values or values within the standard of error of measuring such values. The term “substantially equal” or “about” refers to an amount that is within 5% of the value recited.

As used herein, “a” or “an” means “at least one” or “one or more” unless otherwise indicated. Additionally, “metal removal” refers to removal of one or more types of metal. The transitional term “comprising”, which is synonymous with “including,” “containing,” or “characterized by,” is inclusive or open-ended and does not exclude additional, unrecited elements or method steps. The transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention.

For the purposes of this specification and appended claims, unless otherwise indicated, all numbers expressing quantities, percentages or proportions, and other numerical values used in the specification and claims, are to be understood as being modified in all instances by the term “about.” Furthermore, all ranges disclosed herein are inclusive of the endpoints and are independently combinable. Whenever a numerical range with a lower limit and an upper limit are disclosed, any number falling within the range is also specifically disclosed. Unless otherwise specified, all percentages are in weight percent.

The invention illustratively disclosed herein suitably may be practiced in the absence of any element which is not specifically disclosed herein.

Pyrolysis Oil

“Pyrolysis oil,” as used herein, refers to the liquid oil created from the thermal decomposition of carbon based solid material in an oxygen-deprived environment. The carbon based solid material can be, for example, biomass, waste plastics, and coal. Any pyrolysis oil that contains metals can be used in embodiments of this disclosure. In one embodiment, the pyrolysis oil is made from hardwood, or mixed hardwoods such as oak and maple.

Pyrolysis oil can be created from either slow or fast pyrolysis processes, with the fast process favoring the production of pyrolysis oil and the slow process favoring the production of biochar. Fast pyrolysis generally relates to the rapid heating of the feedstock material in an oxygen deprived environment to around 300-600° C. with a short residence time of around 0.3-5 seconds. Faster pyrolysis can operate at atmospheric pressures and the production of pyrolysis oil can exceed 60% of the products. Different kinds of reactors can be used in the fast pyrolysis production methods, including but not limited to, bubbling fluidized bed, circulating fluidized beds, ablative pyrolysis, and vacuum pyrolysis. Embodiments of the disclosure include the use of pyrolysis oil which has come from any pyrolysis method.

Embodiments of the disclosure include a mixture comprising pyrolysis oil and a solvent, such as ethanol, acetone, propanol, or ethylene glycol. Such pyrolysis oil mixtures have lower kinematic viscosities and improved homogeneity, making metal removal through the use of acidic-ion exchange resins easier. In certain embodiments, the pyrolysis oil mixture comprises about 40-95%, about 50-90%, about 60-88%, or about 75-85% by weight percent pyrolysis oil and about 5-50%, about 10-40%, about 12-30%, about 15-25% by weight percent solvent. In a specific embodiment, the pyrolysis mixture comprises about 85% pyrolysis oil. The pyrolysis oil mixture can also have a kinematic viscosity of less than 60, less than 55, less than 50, less than 45, less than 40, less than 35, less than 30, less than 25, less than 20, less than 15, or less than 10 mm²/s at 20° C. In some embodiments, the mixture has a kinematic viscosity of about 5-60, about 10-50, about 15-30 mm²/s at 20° C. In one embodiment, the organic solvent is combined with a pyrolysis oil having a kinematic viscosity at 20° C. from greater than 200 to 5000 mm²/s to form the pyrolysis oil mixture having a reduced kinematic viscosity at 20° C. less than 60 mm²/s.

Solvent System

Embodiments of the disclosure comprise using an organic solvent or solvent mixture is an alternative way to make pyrolysis oil homogeneous and less viscous to allow the further treatments implemented at room temperature. Embodiments of the disclosure include organic solvents which have at least one of the following properties (1) miscible with pyrolysis oil, (2) no inter-reaction with pyrolysis oil, (3) no negative effects on pyrolysis oil further treatments in refineries, (4) low viscosity, (5) low volatility, (6) cost effective, (7) environmentally friendly, (8) safe to handle, and (9) recyclable. As used herein, “organic solvent,” refers to a liquid that dissolves the pyrolysis oil resulting in a lower viscosity solution. In embodiments, the solvent is ethanol, propanol, ethylene glycol, acetone, or mixtures thereof. In one embodiment, the organic solvent has selected properties, such as: good miscibility with pyrolysis oil, little to no chemical reaction with the pyrolysis oil, imparts little to no negative effects on refinery processes, has low kinematic viscosity, is cost effective, is simple to handle safely, and is recyclable. In one embodiment, the organic solvent can be easily processed in refineries. In one embodiment, the organic solvent comprises a polar C2 to C5 hydrocarbon, or mixtures thereof. Examples of polar hydrocarbons are alcohols, diols, and ketones.

In an embodiment, propanol, ethanol, or mixtures thereof are used as the organic solvent for metal removal processes from pyrolysis oil. The addition of ethanol, for example, improves the homogeneity and reduces the kinematic viscosity of the pyrolysis oil sample down to appropriate levels and makes the process operable at and around room temperature. Specific embodiments of the disclosure include mixtures comprising pyrolysis oil and about 5-50%, about 10-40%, about 12-30%, or about 15-25% by weight percent ethanol, propanol, or mixtures thereof. In a specific embodiment, the mixture comprises pyrolysis oil and about 15% by weight percent ethanol, propanol, or mixtures thereof.

Ethylene glycol (IUPAC name: ethane-1,2-diol) is an organic compound of the formula HO—CH₂—CH₂—OH. Ethylene glycol is a commercially available solvent which meets almost all of the above listed properties. Acetone (propanone) is an organic compound with the chemical formula (CH₃)₂CO. Embodiments of the disclosure include a pyrolysis oil mixture comprising pyrolysis oil, acetone, and ethylene glycol. This pyrolysis oil mixture was found to have a lower kinematic viscosity, which can improve the metal removal process. Embodiments of the disclosure include pyrolysis oil mixtures comprising between 10-70% pyrolysis oil, 10-50% ethylene glycol, and 5-20% acetone. In specific embodiments, the pyrolysis oil mixtures comprise 40-50% pyrolysis oil, 40-50% ethylene glycol, and 5-15% acetone.

Metals Removal

Embodiments of the disclosure have been found suitable for further dissolving pyrolysis oil and then removing metals from the pyrolysis oil. As discussed above, the mixtures of pyrolysis oil and organic solvent are used to improve the homogeneity and to reduce the kinematic viscosity of the pyrolysis oil, thus, enabling the efficient removal of metals without the need to heat the pyrolysis oil. For example, the pyrolysis oil mixture can undergo metal removal at less than 100° C., less than 80° C., less than 70° C., less than 60° C., less than 50° C., less than 40° C., less than 30° C. or around 20° C. In certain embodiments, the pyrolysis oil mixture can undergo metal removal between 15° C.-100° C., 15° C.-30° C., 20° C.-60° C., or 20° C.-30° C. In one embodiment the method for removing metals from pyrolysis oil is conducted at a temperature between 15° C. and 40° C. In a specific embodiment, the pyrolysis oil mixture can undergo metal removal at room temperature.

In one embodiment, the metals are reduced to 15 ppmw or less in the reduced metal content pyrolysis oil mixture. In some embodiments, the metals are reduced to 10 ppmw or less, or even 5 ppmw or less.

Ion-Exchange Resins

Ion-exchange resins are highly ionic, covalently cross-linked, insoluble polyelectrolytes supplied as solids, such as beads. The ion-exchange resins can have either a dense internal structure with no discrete pores or can have a porous, multi-channeled structure. In one embodiment, the ion-exchange resin is a macro-reticular resin, which is an ionic-exchange resin made of two continuous phases: a continuous pore phase and a continuous gel polymeric phase. In one embodiment, the ion-exchange resin comprises an organic polymeric support. Examples of organic polymeric supports are polystyrene and polyacrylic acid.

The ion exchange resins that are effective for the method for removing metals from the pyrolysis oil mixture are acidic. In one embodiment, the acidic ion-exchange resin is sulfonated. In one embodiment, the acidic ion-exchange resin is a strongly acid ion-exchange resin. Strongly acid ion-exchange resins contain sulfonic acid groups or their corresponding salts and they are strong cation exchangers. Some non-limiting examples of useful acidic ion-exchange resins include those manufactured by Dow Chemical Co, under the tradenames of DOWEX® MARATHON C, DOWEX® MONOSPHERE C-350, DOWEX® HCR-S/S, DOWEX® MARATHON MSC, DOWEX® MONOSPHERE 650C, DOWEX® HCR-W2, DOWEX® MSC-1, DOWEX® HGR NG (H), DOWEX® DR-G8, DOWEX® 88, DOWEX® MONOSPHERE 88, DOWEX® MONOSPHERE C 600B, DOWEX® MONOSPHERE M-31, DOWEX® MONOSPHERE DR-2030, DOWEX® M-31, DOWEX® G-26 (H), DOWEX® 50W-X2, DOWEX® 50W-X4, DOWEX® 50W-X8, DOWEX® 66, and Duolite® C-26. Some other non-limiting examples of acidic ion-exchange resins include those manufactured by Rohm and Haas, under the tradenames of Amberlyst® 131, Amberlyst® 15, Amberlyst® 15 Wet, Amberlyst® 16, Amberlyst® 31, Amberlyst® 33, Amberlyst® 35, Amberlyst® 36, Amberlyst® 36 Wet, Amberlyst® 39, Amberlyst® 40, Amberlyst® 70, Amberlyst® 131(H), Amberlyst® XN-1010, Amberlite® FPC11, Amberlite® FPC22, Amberlite® FPC23, and Amberlite® IR120 Plus (H). Other non-limiting examples of acidic ion-exchange resins include those manufactured by Brotech Corp., under the tradenames Purofine® PFC150, Purolite® C145, Purolite® C150, Purolite® C160, Purofine® PFC100, and Purolite® C100. Additional non-limiting examples of acidic ion-exchange resins include those manufactured by Thermax Limited Corp., under the tradenames of Monoplus™ 5100, and Tulsion® T42.

Some examples of ion-exchange resins that are weakly acidic cation exchangers include Amberlite® CG-50 Type I, Amberlite® IRC-50, Amberlite® IRC-50S, Amberlite® IRP-64, and DOWEX® CCR-3. These weakly acidic cation exchangers contain carboxylic acid groups or the corresponding salts. In one embodiment, the weakly acidic cation exchangers can be less effective at removing the metals from the pyrolysis oil mixture and they can either require additional contact time or a higher weight ratio of the acidic ion-exchange resin to the pyrolysis oil mixture to obtain an acceptable percentage of metals removal.

In one embodiment, the ion-exchange resin has a maximum operating temperature of less than 100° C., or less than 60° C.

It is found that the metals in the above described pyrolysis oil mixtures can be removed with acidic ion-exchange resins. Adding acetone into a pyrolysis oil-ethylene glycol solution makes a less viscous pyrolysis oil mixture that is easier to pass through selected filtration media at room temperature under one atmosphere or less pressure to separate adsorbent/resin from the solution. Example 2 evaluates different acidic ion-exchange resins for removing metals from the pyrolysis oil and ethanol mixtures.

Embodiments of the disclosure include removing metals from a pyrolysis oil mixture comprising pyrolysis oil and a solvent. Metal removal can be accomplished through the use of acidic ion-exchange resins. In specific embodiments, the acidic ion-exchange resins are strongly acid ion-exchange resins. The manufactures of ion-exchange resins mark the resins as strong or weak. The ion-exchange resins may be used free in the pyrolysis oil mixture, or may be implemented in a column. Additionally, in one embodiment, the method for removing metals from pyrolysis oil may be implemented at temperatures between the ranges of 15° C.-40° C., such as around room temperature.

In one embodiment, a weight ratio of the acidic ion-exchange resin to the pyrolysis oil mixture during the step of removing the metals from the pyrolysis oil mixture is selected to achieve a desired level of metals in the reduced metal content pyrolysis oil mixture. In one embodiment, the weight ratio of the acidic ion-exchange resin to the pyrolysis oil mixture is less than 10.

In one embodiment, the removing of the metals occurs over a time from 0.5 to 10 hours.

### EXAMPLES

The following examples are included to demonstrate specific embodiments of the disclosure. It should be appreciated by those of skill in the art that the techniques disclosed in the examples that follow represent techniques discovered by the inventors to function well in the practice of the invention, and thus, can be considered to constitute modes for its practice. However, those skilled in the art should, in light of the present disclosure, appreciate that many changes can be made in the specific embodiments disclosed and still obtain a like or similar result without departing from the spirit and scope of the invention.

### Example 1

The kinematic viscosities of pure pyrolysis oil and mixtures of pyrolysis oil+ethylene glycol, and pyrolysis oil+ethylene glycol+acetone were compared. Kinematic viscosity was measured by ASTM D445-12. Table 1 shows that with adding 10% acetone, the kinematic viscosity is reduced by about 50% more than in the mixture of pyrolysis oil+ethylene glycol.

TABLE 1
Kinematic viscosities of a sample of pyrolysis
oil and pyrolysis oil mixtures, mm²/s

| | Example Pyrolysis Oil | | |
|---|---|---|---|
| Temperature | | 50% Oil + 50% | 45% Oil + 45% |
| ° C. | 100% Oil | Glycol | Glycol + 10% Acetone |
| 20 | 425 | 46.8 | 22.8 |
| 40 | 51.0 | 17.2 | 9.4 |
| 60 | 19.7 | 7.7 | 4.8 |

45% pyrolysis oil:45% ethylene glycol:10% acetone was found to be a good mixture for reducing the kinematic viscosity of the pyrolysis oil used in this example. The kinematic viscosity at 20 degrees Celsius for such a pyrolysis oil mixture was almost the same as the “pure” pyrolysis oil's kinematic viscosity at 60 degrees Celsius. The measured kinematic viscosities of pyrolysis oil, pyrolysis oil/ethylene glycol solution, and pyrolysis oil/ethylene glycol/acetone solution at three different temperatures are listed above in Table 1. Such combinations of the pyrolysis oil with the organic solvents formed the pyrolysis oil mixture homogeneous and stable, and also made the metal removal process operable at room temperature with no heating needed. Room temperature in the context of this disclosure is the same as ambient temperature, and is generally in the range of 20 to 25° C.

FIG. 2 shows the equilibrium isotherm study result with a strongly acid ion-exchange resin (Acidic Resin B). The study was conducted with pyrolysis oil samples in ethylene glycol and acetone solution at room temperature. Five metal contents, calcium, iron, potassium, magnesium, and sodium, were measured. The metal contents were measured with an Inductively Coupled Plasma (ICP) spectrometer, Thermo iCap 6500 Radial ICP (Thermo Scientific, UK), and reported in parts per million by weight (ppmw). Sodium was removed with 0.5% (in weight) acidic ion-exchange resin. Three of the five metals were removed at the weight ratio of 1.2%, ion-exchange resin to pyrolysis oil W_{f}/Wₒ, while iron used about 3.3%. In this example, the ion-exchange resin was put free into the pyrolysis oil mixture and shaken for 24 hours, but this example could have also been run in a column. The reduced metal content pyrolysis oil mixture then underwent vacuum filtration to separate the ion-exchange resin from the pyrolysis oil. 20 grams of pyrolysis oil and organic solvent was used in each pyrolysis oil mixture.

### Example 2

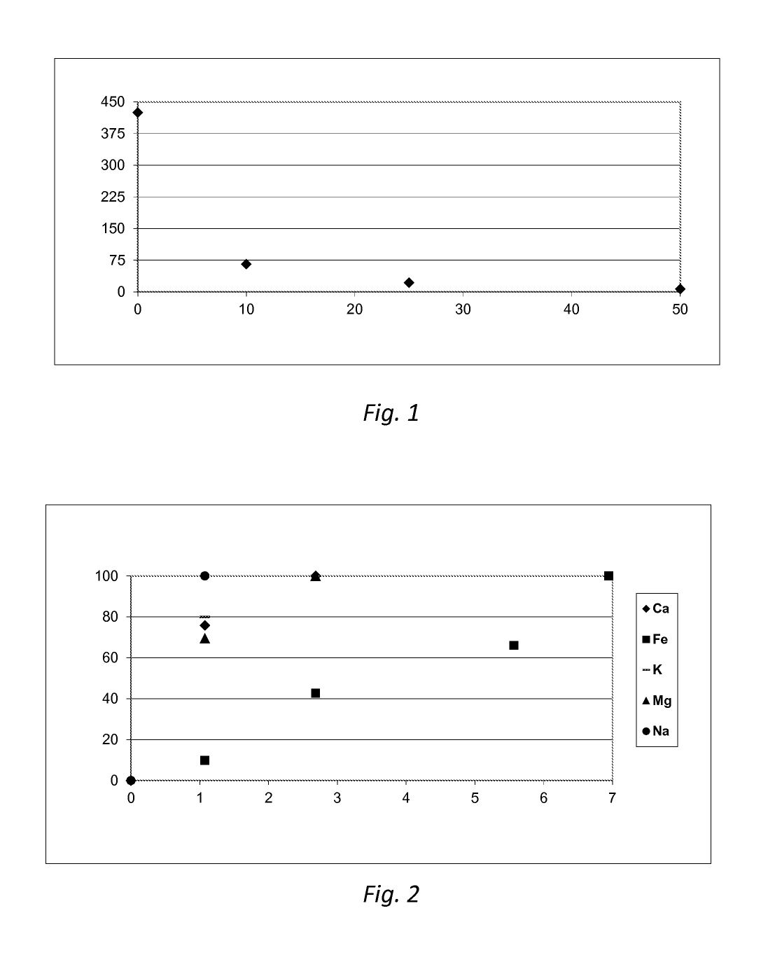

Propanol was chosen as the organic solvent for this example to demonstrate the metal removal process from pyrolysis oil. A 15 weight % addition of propanol was found to reduce the kinematic viscosity at 20° C. of the pyrolysis oil sample down to an appropriate level (FIG. 1) in the pyrolysis oil mixture; and made the method for removing the metals from the pyrolysis oil mixture operable at room temperature.

A term of “percentage of removal” was used to evaluate the efficiency of metal removal. It is calculated by Equation 1, below. Calculated percentage of removal value would be 100% when the concentration of metal, measured by ICP, is 5 ppmw or less.

Percentage of removal=100×(Cₒ−C)/Cₒ(%) Equation-1

Where Cₒ is the initial concentration, in ppmw, of the element in the sample of pyrolysis oil mixture, and
C is the concentration, in ppmw, of the element in the reduced metal content pyrolysis oil mixture.

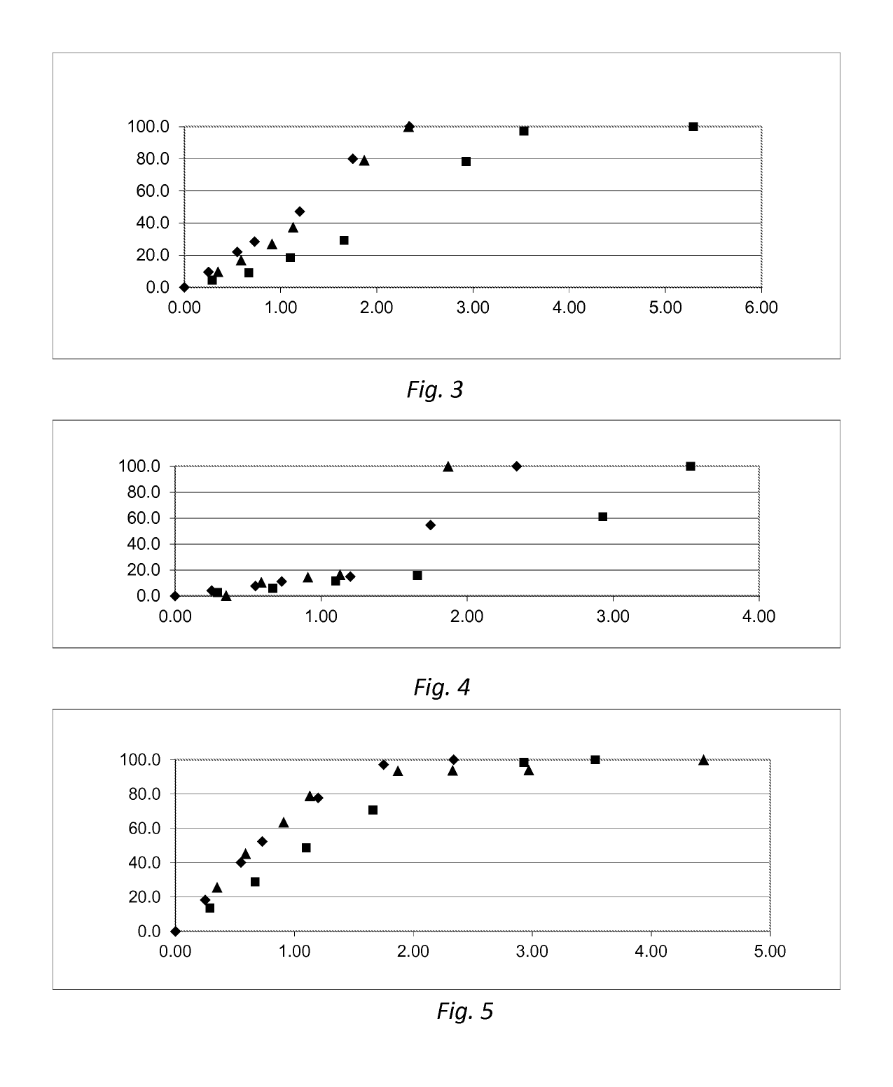

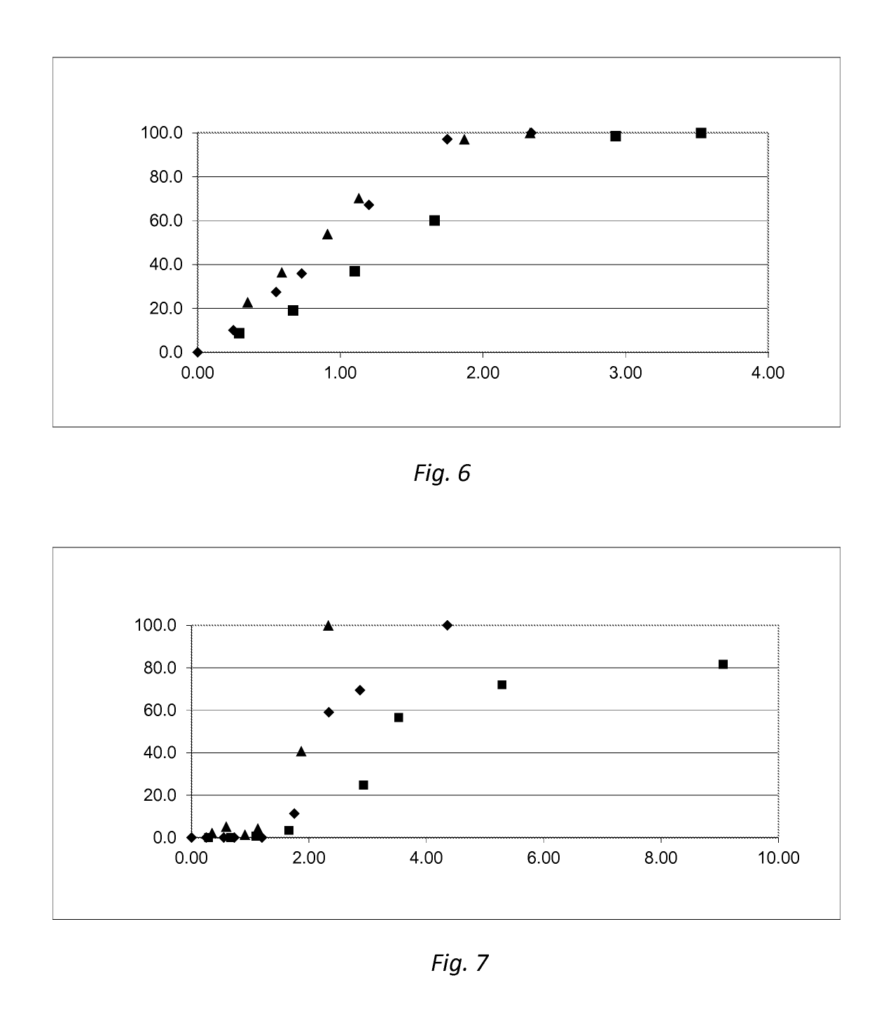

In order to determine which type of adsorbents or ion-exchange resins is an appropriate material for removing potassium (K), sodium (Na), calcium (Ca), magnesium (Mg), and iron (Fe) from pyrolysis oil, fifteen (15) adsorbents and ion-exchange resins were investigated with an equilibrium isotherm study. The results using three highly acid ion-exchange resin runs for each metal are shown in FIGS. 3-7. The three different highly acid ion-exchange resins are represented by three different labels in the FIGS. 3-7; triangle represents Acidic Resin A, diamond represents Acidic Resin B, and square represents Acidic Resin C. Acidic Resin A was Amberlyst® 36 Wet, Acidic Resin B was Amberlyst® 15, and Acidic Resin C was Amberlite® IR120 Plus (H).

FIGS. 3-7 show that a weight ratio of the acidic ion-exchange resin to the pyrolysis oil mixture from 2.0 to 6.0 provided 100 percentage of removal of one or more of the metals when selected strongly acid ion-exchange resins were used. When using Acidic Resin B, all five metals (Na, K, Mg, Ca, and Fe) were 100% removed at a weight ratio of 4.3. The amount of metals removed at this weight ratio, and using Acidic Resin B, totaled about 60 micro-equivalents of cations.

In general, the affinity order for cation removal that we measured when using strongly acid ion-exchange resins was Na⁺>K⁺>Mg²⁺>Ca²⁺>>Fe³⁺>H⁺. It appeared that the ion-exchange rate was correlated to the strength of the electrostatic field of each cation. For the cations with the same valence, the larger cations were slower to exchange that the smaller cations.

### Example 3

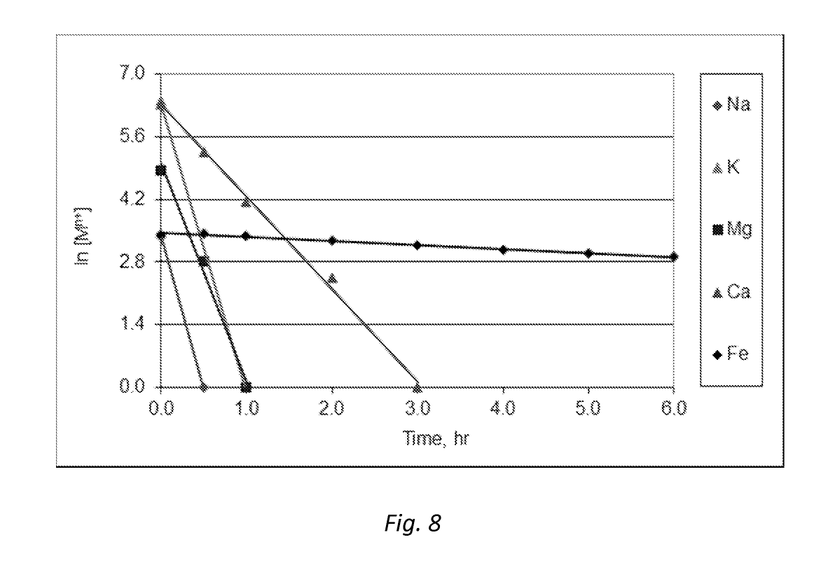

A pyrolysis oil mixture comprising 15 wt % ethanol and 85 wt % pyrolysis oil was used for a kinetic study of the metals removal. The pyrolysis oil mixture was mixed with Amberlyst® 15 ion-exchange resin (Acidic Resin B) in a glass container. The reduced metal content pyrolysis oil mixture was analyzed by ICP at different time intervals, and the results are shown in FIG. 8.

The removing of the metals was found to be a pseudo first-order process for the individual metal cations.

A first order process depends on the concentration of only one reactant (a unimolecular reaction). Other reactants can be present, but each will be zero order. The rate law for a process that is first order with respect to a reactant A is

$$\frac{- d [ A ]}{d t} ≡ r ≡ k [ A ] \qquad Equation \text{-} 2$$

k is the first order rate constant, which has units of 1/s. Measuring a second order reaction rate with reactants A and B can be problematic: The concentrations of the two reactants must be followed simultaneously, which is more difficult; or measure one of them and calculate the other as a difference, which is less precise. A common solution for that problem is the pseudo-first order approximation.

If the concentration of one of a reactants remains constant because it is supplied in great excess, its concentration can be absorbed within the rate constant, obtaining a pseudo first order process constant, because in fact, it depends on the concentration of only one reactant. If, for example, [B] remains constant, then:

r=k[A][B]=k′[A] Equation-3

where k′=k[B]a (k′ or k_{obs} with units s⁻¹) and an expression is obtained identical to the first order expression above. One way to obtain a pseudo-first order process is to use a large excess of one of the reactants (e.g., [B]>>[A]) would work for the previous example) so that, as the reaction progresses, only a small amount of the reactant is consumed, and its concentration can be considered to stay constant. By collecting k′ for many reactions with different (but excess) concentrations of [B], a plot of k′ versus [B] gives k (the regular second order rate constant) as the slope.

### Example 4

The kinematic viscosities of a sample of pyrolysis oil, and of the sample pyrolysis oil ores made by blending the sample of pyrolysis oil with: 1) ethanol, 2) propanol or 3) a 1:1 mixture of ethanol and propanol, were measured at 20° C., as shown below in Table 2.

TABLE 2
Viscosities (mm²/s) of the example pyrolysis oil and its
pyrolysis oil mixtures with varied organic solvents

| Mix Ratio, w/w % | | | | |
|---|---|---|---|---|
| | | 1:1 Ethanol | | Kinematic |
| | | and Propanol | Pyrolysis | viscosity at |
| Ethanol | Propanol | Mixture | Oil | 20° C., mm²/s |
| 0 | | | 100 | 424.6 |
| 10 | | | 90 | 65.94 |
| 25 | | | 75 | 21.66 |
| 50 | | | 50 | 7.087 |
| | 10 | | 90 | 78.43 |
| | 25 | | 75 | 32.87 |
| | 50 | | 50 | 12.20 |
| 5 | 5 | 10 | 90 | 71.98 |
| 12.5 | 12.5 | 25 | 75 | 26.85 |
| 25 | 25 | 50 | 50 | 9.231 |

### REFERENCES

US2012/0317871
Finish Thompson Inc. Recovery of waste engine coolants using advanced vacuum distillation technology.

What is claimed is:

1. A method for removing metals from pyrolysis oil comprising
combining pyrolysis oil and an organic solvent to form a pyrolysis oil mixture having a kinematic viscosity at 20° C. less than 60 mm²/s; and
removing the metals from the pyrolysis oil mixture to produce a reduced metal content pyrolysis oil mixture.

2. The method of claim 1, wherein removing the metals from the pyrolysis oil mixture comprises using an acidic ion-exchange resin.

3. The method of claim 2, wherein the acidic ion-exchange resin is a strongly acid ion-exchange resin.

4. The method of claim 1, further comprising mixing the pyrolysis oil and the organic solvent together prior to removing the metals.

5. The method of claim 4, wherein the mixing is active or passive.

6. The method of claim 1, wherein the pyrolysis oil mixture comprises 40-95% pyrolysis oil and 5-60% organic solvent.

7. The method of claim 1, wherein the organic solvent is ethanol, propanol, or mixtures thereof.

8. The method of claim 7, wherein the pyrolysis oil mixture comprises 5-40% ethanol.

9. The method of claim 8, wherein the pyrolysis oil mixture comprises 10-20% ethanol.

10. The method of claim 1, wherein the organic solvent comprises ethylene glycol and acetone.

11. The method of claim 10, wherein the pyrolysis oil mixture comprises 40-50% pyrolysis oil, 40-50% ethylene glycol, and 5-15% acetone.

12. The method of claim 1, wherein the kinematic viscosity is less than 40 mm²/s at 20° C.

13. The method of claim 1, wherein the pyrolysis oil mixture is filtered prior to removing the metals.

14. The method of claim 1, wherein the pyrolysis oil mixture is not filtered prior to removing the metals.

15. The method of claim 1, wherein the pyrolysis oil mixture is not heated prior to or during removing the metals.

16. The method of claim 1, wherein the pyrolysis oil mixture is less than 100° C. prior to or during removing the metals.

17. The method of claim 1, wherein the removing the metals is a pseudo first-order process for individual metal cations.

18. The method of claim 1, wherein the method is conducted at a temperature between 15° C. and 40° C.

19. The method of claim 1, wherein the metals are reduced to 5 ppmw or less in the reduced metal content pyrolysis oil mixture.

20. The method of claim 2, wherein a weight ratio of the acidic ion-exchange resin to the pyrolysis oil mixture is from 2.0 to 6.0.
